(19) United States
(12) Patent Application Publication
(10) Pub. No.: US 2024/0073375 A1
(43) Pub. Date: Feb. 29, 2024

(54) VEHICLE SURROUNDINGS MONITORING SYSTEM, VEHICLE, IMAGE PROCESSING DEVICE, AND VEHICLE SURROUNDINGS MONITORING METHOD

(71) Applicant: TOYOTA JIDOSHA KABUSHIKI KAISHA, Toyota-shi (JP)

(72) Inventor: Takayuki HATORI, Nagakute-shi (JP)

(73) Assignee: TOYOTA JIDOSHA KABUSHIKI KAISHA, Toyota-shi (JP)

(21) Appl. No.: 18/330,450

(22) Filed: Jun. 7, 2023

(30) Foreign Application Priority Data
Aug. 26, 2022 (JP) 2022-135127

(51) Int. Cl. H04N 7/18; B60R 1/22; G06T 7/00; H04N 5/268

(52) U.S. Cl. CPC H04N 7/183; B60R 1/22; G06T 7/0002; H04N 5/268; B60R 2300/30; G06T 2207/10016; G06T 2207/30252

(57) ABSTRACT

A vehicle surroundings monitoring system includes: an acquisition unit that acquires a first video including a video in which an area behind a vehicle is captured; an image processing unit that generates a second video to be displayed on a display unit of the vehicle, based on the first video; a video switching unit to which the first video and the second video are input, and that outputs the first video or the second video to the display unit in accordance with a state of the second video; and a setting switching unit that forcibly switches a setting of the display unit to a setting for the first video when the video switching unit outputs the first video.

### CROSS-REFERENCE TO RELATED APPLICATION

This application claims priority to Japanese Patent Application No. 2022-135127 filed on Aug. 26, 2022, incorporated herein by reference in its entirety.

### BACKGROUND

### 1. Technical Field

The present disclosure relates to a vehicle surroundings monitoring system, a vehicle, an image processing device, and a vehicle surroundings monitoring method.

### 2. Description of Related Art

There is known a vehicle surroundings monitoring system that displays a video in which an area behind a vehicle is captured by a rear camera on an in-vehicle display in real time when the vehicle is backing up (see, for example, Japanese Unexamined Patent Application Publication No. 2021-172243 (JP 2021-172243 A)).

### SUMMARY

It is dangerous when a video in which surroundings of (for example, an area behind) the vehicle are captured is fixed. Therefore, high reliability is needed for the vehicle surroundings monitoring system that displays the image in which the surroundings of the vehicle are captured. At the same time, there is a demand to provide various types of image-processed content using videos in which the surroundings of the vehicle are captured.

However, with the technique of the related art, it is difficult for the vehicle surroundings monitoring system to display a video in which the surroundings of the vehicle are captured, with high reliability, and to provide various types of image-processed content using the video.

An embodiment of the present disclosure has been made in view of the above issues, and makes it possible that the vehicle surroundings monitoring system displays a video in which the surroundings of a vehicle are captured, with high reliability, and provides various types of image-processed content using the video.

In order to solve the above issues, a vehicle surroundings monitoring system according to the embodiment of the present disclosure includes: an acquisition unit configured to acquire a first video including a video in which an area behind a vehicle is captured; an image processing unit configured to generate a second video to be displayed on a display unit of the vehicle, based on the first video; a video switching unit that is configured such that the first video and the second video are input, and that is configured to output the first video or the second video to the display unit in accordance with a state of the second video; and a setting switching unit configured to forcibly switch a setting of the display unit to a setting for the first video when the video switching unit outputs the first video.

In accordance with an embodiment of the present embodiment, it is possible that the vehicle surroundings monitoring system displays the video in which the surroundings of the vehicle are captured, with high reliability, and easily provides various types of image-processed content using the video.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a system configuration of a vehicle surroundings monitoring system according to a present embodiment;

FIG. 2 is a diagram (1) showing another example of a system configuration of a vehicle surroundings monitoring system;

FIG. 3 is a diagram (2) showing still another example of a system configuration of a vehicle surroundings monitoring system;

FIG. 4 is a diagram showing an example of a hardware configuration of an image processing device according to the present embodiment;

FIG. 5 is a flowchart showing an example of display processing of a rear video according to the present embodiment;

FIG. 6 is a flowchart showing another example of the display processing of the rear video according to the present embodiment; and

FIG. 7 is a diagram showing an example of a second video according to the present embodiment.

### DETAILED DESCRIPTION OF EMBODIMENTS

Hereinafter, the present embodiment (embodiment of the present disclosure) will be described below with reference to the drawings. In the present specification and drawings, constituent elements having substantially the same functional configuration are denoted by the same reference signs, thereby not repeating description thereof.

System Configuration

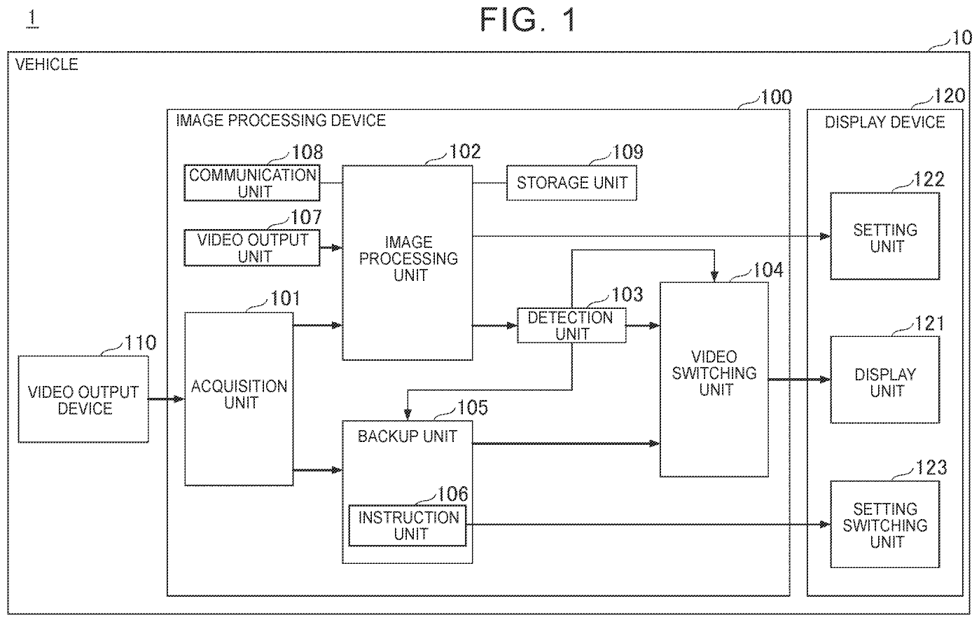

FIG. 1 is a diagram showing an example of a system configuration of a vehicle surroundings monitoring system according to the present embodiment. The vehicle surroundings monitoring system 1 is a system that is mounted on a vehicle 10 such as an automobile and that displays a video of the surroundings including an area behind the vehicle 10 on a display device 120 in real time. In the example of FIG. 1, the vehicle surroundings monitoring system 1 includes a video output device 110, an image processing device 100, and a display device 120.

The video output device 110 is a device that outputs to the image processing device 100 a video (hereinafter referred to as a first video) of the surroundings of the vehicle 10 that includes a video in which the area behind the vehicle 10 is captured. As an example, the video output device 110 is an electronic control unit such as a panoramic view monitor (PVM) electronic control unit (ECU) that generates a video of the surroundings of the vehicle 10 using a front image, a rear image, a right side image, and a left side image captured by a plurality of cameras. As another example, the video output device 110 is a rear camera or the like that captures the area behind the vehicle 10.

The image processing device 100 is a device that combines the first video input from the video output device 110 with one or more other videos (or images) to generate a display video (hereinafter referred to as a second video), and that causes the generated second video to be displayed on the display device 120. Here, the one or more other videos may be generated by the image processing device 100, or may be input from another ECU or the like. The image processing device 100 is an electronic control unit such as a multimedia ECU that causes the display device 120 to display, for example, a navigation image, a digital versatile disc (DVD) video, a television video, an information image of the vehicle 10, a setting image of the vehicle 10, a rear video of the vehicle 10, and the like.

As an example, the image processing device 100 includes an acquisition unit 101, an image processing unit 102, a detection unit 103, a video switching unit 104, a backup unit 105, a video output unit 107, a communication unit 108, and the like, as shown in FIG. 1.

The acquisition unit 101 acquires the first video that is output by the video output device 110. The first video includes the video in which the area behind the vehicle 10 is captured. The acquisition unit 101 is implemented by, for example, an input circuit or the like included in the image processing device 100.

The image processing unit 102 generates the second video to be displayed on a display unit 121, based on the first video acquired by the acquisition unit 101. Here, the second video generated by the image processing unit 102 may include, for example, a navigation image, a video of the surroundings of the vehicle 10, a DVD video, a television video, a display image of vehicle information, a setting image of the vehicle 10, an image of an operation button, and the like. In addition, the image processing unit 102 sets the settings (for example, luminance, contrast, brightness, and the like) for the generated second video in the display device 120.

Desirably, the image processing unit 102 can use the first video acquired by the acquisition unit 101 to further generate content to be provided to an external device such as a driving recorder or a smartphone.

The image processing unit 102 is implemented, for example, by a program or the like executed by a computer included in the image processing device 100. However, the way to implement the image processing unit 102 is not limited to this, and the image processing unit 102 may be implemented by, for example, a combination of a program executed by a computer included in the image processing device 100 and hardware for image processing, etc.

The detection unit 103 detects an abnormality in the second video output by the image processing unit 102. For example, when the image processing unit 102 does not output the second video, or when the video output by the image processing unit 102 is fixed (frozen), the detection unit 103 outputs a detection result indicating that there is an abnormality in the second video to the backup unit 105, the video switching unit 104, and the like.

The detection unit 103 is implemented by, for example, a detection circuit or the like included in the image processing device 100. However, the way to implement the detection unit 103 is not limited to this, and the detection unit 103 may be implemented by, for example, a program executed by a computer included in the image processing device 100 or a combination of the program and hardware, etc.

The first video and the second video output by the image processing unit 102 are input to the video switching unit 104, and the video switching unit 104 selectively outputs to the display device 120 (display unit 121) the first video or the second video in accordance with the state of the second video. For example, when the detection unit 103 detects an abnormality in the second video, the video switching unit 104 outputs the input first video to the display device 120. On the other hand, when the detection unit 103 does not detect an abnormality in the second video, the video switching unit 104 outputs the input second video to the display device 120.

The video switching unit 104 is implemented, for example, by a program executed by a computer included in the image processing device 100 and an output circuit, etc. However, the way to implement the video switching unit 104 is not limited to this, and the video switching unit 104 may be implemented by hardware or the like.

The backup unit 105 outputs the first video input from the acquisition unit 101 to the video switching unit 104. For example, the backup unit 105 holds the first video input from the acquisition unit 101, and outputs the held first video to the video switching unit 104 when the detection unit 103 detects an abnormality in the second video. Alternatively, the backup unit 105 may output the first video input from the acquisition unit 101 to the video switching unit 104 as it is.

Further, the backup unit 105 includes an instruction unit 106 configured to issue an instruction to the display device 120 to forcibly switch the setting of the display unit 121 of the display device 120 to the setting for the first video when the video switching unit 104 outputs the first video.

The backup unit 105 is implemented by, for example, a backup circuit or the like included in the image processing device 100. Alternatively, the backup unit 105 may be, for example, a microcomputer or the like that implements the functions of the backup unit 105 by executing a predetermined program.

The video output unit 107 outputs another video that is different from the first video to the image processing unit 102. For example, the video output unit 107 outputs a navigation image, a DVD video, a television image, or the like to the image processing unit 102. The other video output by the video output unit 107 may be generated by the video output unit 107, or may be input from another ECU or the like.

The video output unit 107 is implemented, for example, by a program executed by a computer included in the image processing device 100, an input circuit included in the image processing device 100, or the like.

For example, the communication unit 108 connects the image processing device 100 to an in-vehicle network of the vehicle 10 so as to communicate with other electronic control units (ECUs). Also, the communication unit 108 communicates with an information terminal such as a smartphone, for example, through wireless communication such as wireless local area network (LAN) communication or short-range wireless communication, or wired communication such as universal serial bus (USB). Note that the communication unit 108 may communicate with an information terminal such as a smartphone using a communication module such as a data communication module (DCM) provided in the vehicle 10.

The communication unit 108 is implemented by, for example, a program executed by a computer included in the image processing device 100, a communication interface (I/F) included in the image processing device 100, and the like.

A storage unit 109 is, for example, a storage unit that stores content and the like generated by the image processing unit 102 and provided to an external device. The storage unit 109 is implemented by, for example, a program executed by a computer included in the image processing device 100, a storage device included in the image processing device 100, and the like. Note that the storage unit 109 may be provided outside the image processing device 100.

Note that the functional configuration of the image processing device shown in FIG. 1 is an example. For example, the detection unit 103 may be included in the backup unit 105, the video switching unit 104, or the like. Also, the backup unit 105 may be included in the video switching unit 104. Furthermore, the instruction unit 106 may be provided outside the backup unit 105.

The display device 120 is, for example, a device such as a center display in the vehicle 10 that displays the first video or the second video output by the image processing device 100. The display device 120 includes, for example, the display unit 121, a setting unit 122, a setting switching unit 123, and the like.

The display unit 121 is a display panel such as a liquid crystal display (LCD) or an organic light emitting diode (OLED), for example, that displays the first video or the second video input from the image processing device 100.

The setting unit 122 sets the settings (for example, luminance, contrast, brightness, and the like) for the second video in the display unit 121 in accordance with the instruction from the image processing unit 102 of the image processing device 100.

When the video switching unit 104 of the image processing device 100 outputs the first video, the setting switching unit 123 forcibly changes the setting of the display unit 121 to the setting for the first video in accordance with the instruction from the instruction unit 106 of the image processing device 100. Here, the setting for the first video includes a setting value of luminance, contrast, brightness, or the like that is needed to display the first video. For example, the setting switching unit 123 holds in advance the setting value of the display unit 121 for satisfying the conditions stipulated by laws and regulations as the setting for the first video. In addition, in accordance with the instruction from the instruction unit 106, the held setting for the first video is set in the display unit 121.

### Comparative Example 1

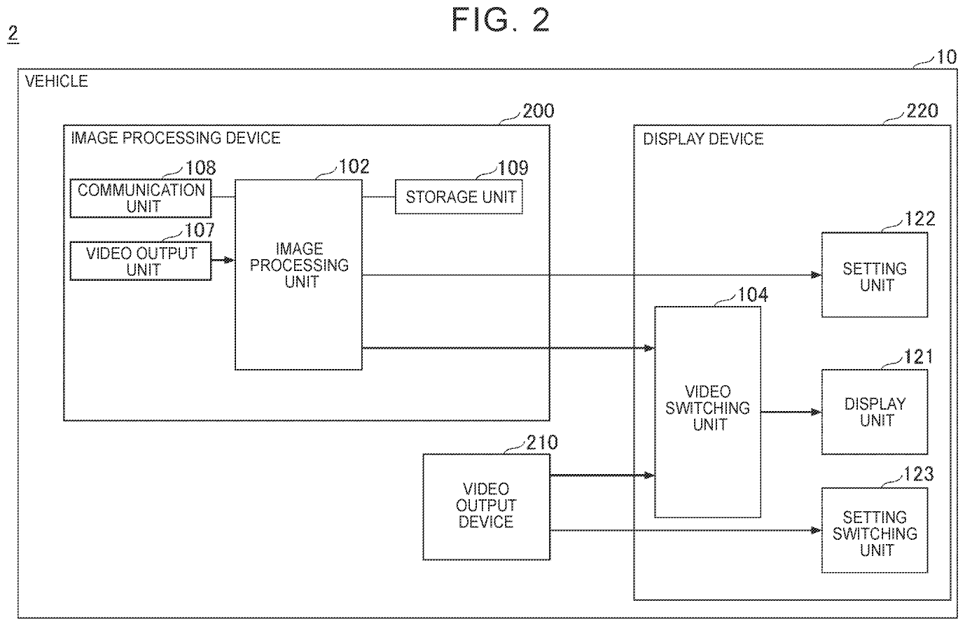

FIG. 2 is a diagram (1) showing another example of a system configuration of a vehicle surroundings monitoring system. In the example of FIG. 2, in a vehicle surroundings monitoring system 2, a video output device 210 is configured to directly output to a display device 220 the first video including the video in which the area behind the vehicle 10 is captured, and to issue an instruction to the setting switching unit 123 of the display device 220 to set the setting for the first video.

Further, the display device 220 includes the video switching unit 104 to which the first video and the second video output by an image processing device 200 are input, and that switches the video output to the display unit 121 from the second video to the first video when the vehicle 10 is backing up. With the system configuration shown in FIG. 2, the vehicle surroundings monitoring system 2 can display the first video in which the surroundings of the vehicle 10 are captured on the display device 220, with high reliability, when the vehicle 10 is backing up or the like.

However, in the system configuration in FIG. 2, there is a problem that various types of image-processed content cannot be provided using the first video output by the video output device 210. For example, in the system configuration in FIG. 2, the vehicle surroundings monitoring system 2 cannot display information about the vehicle 10, information about objects around the vehicle 10, or the like on the display device 220 together with the first video. In the configuration in FIG. 2, the vehicle surroundings monitoring system 2 cannot generate content to be provided to an external device such as a driving recorder or a smartphone, for example, using the first video output by the video output device 210.

### Comparative Example 2

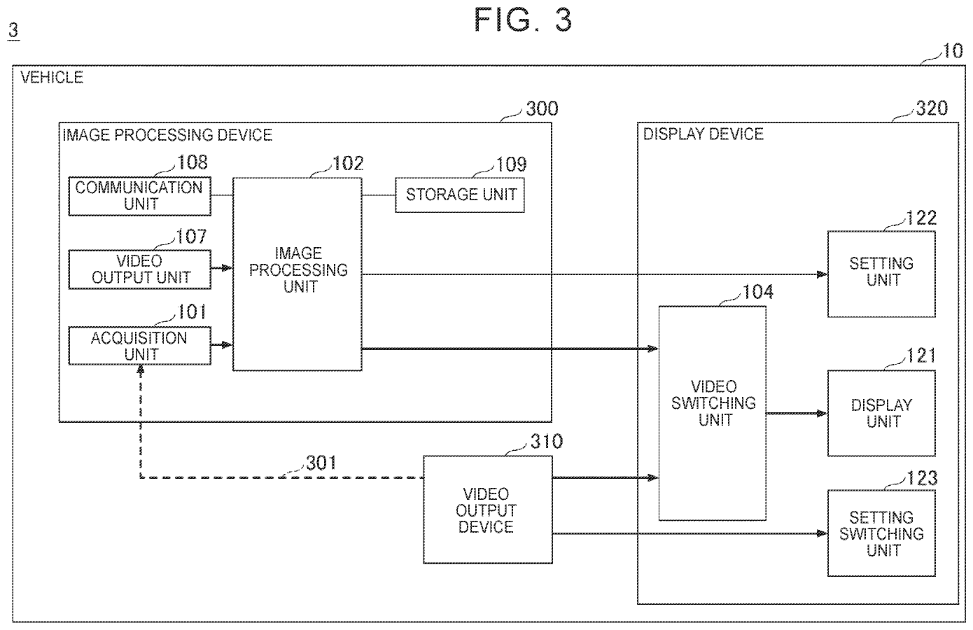

FIG. 3 is a diagram (2) showing another example of a system configuration of a vehicle surroundings monitoring system. In addition to the system configuration of the vehicle surroundings monitoring system 2 shown in FIG. 2, a vehicle surroundings monitoring system 3 shown in FIG. 3 includes a harness 301 that outputs the first video from a video output device 310 to an image processing device 300, and the acquisition unit 101 of the image processing device 300 that acquires the first video.

With the system configuration shown in FIG. 3, the vehicle surroundings monitoring system 3 can display the first video in which the surroundings of the vehicle 10 are captured on the display device 320, with high reliability, when the vehicle 10 is backing up or the like, as in the vehicle surroundings monitoring system 2 shown in FIG. 2. In the vehicle surroundings monitoring system 3, the image processing device 300 can generate content to be provided to an external device such as a driving recorder or a smartphone, for example, using the first video output by the video output device 310.

However, in the system configuration of FIG. 3, a video input/output circuit and the harness 301 are needed between the video output device 310 and the image processing device 300. As a result, disadvantages such as an increase in weight due to the harness 301, an increase in the size of the video output device 310, and an increase in system cost are increased. Further, in the system configuration in FIG. 3, the vehicle surroundings monitoring system 3 cannot display information about the vehicle 10, information about objects around the vehicle 10, or the like on the display device 320 together with the first video when the vehicle is backing up.

A method can be considered in which the image processing device 300 creates a second video that displays information about the vehicle 10, information about objects around the vehicle 10, or the like and causes the display device 320 to display the second video together with the first video. However, the method has the problem that it is difficult to ensure the reliability of the software. For example, when the processing of the image processing device 300 freezes for some reason, or when the image processing device 300 is restarted, the vehicle surroundings monitoring system 3 cannot display a video of the surroundings of the vehicle 10 on the display device 320 in real time.

As described above, it is difficult for the vehicle surroundings monitoring system to display the video in which the surroundings of the vehicle 10 are captured, with high reliability, and to provide various types of image-processed content using the video.

Therefore, in the vehicle surroundings monitoring system 1 according to the present embodiment, as shown in FIG. 1, the video output device 110 outputs the first video only to the image processing device 100, and the image processing device 100 generates various types of content such as the second video using the first video. As a result, the vehicle surroundings monitoring system 1 can provide various types of image-processed content using the first video output by the video output device 110 while suppressing an increase in weight due to the harness, an increase in the size of the video output device 110, an increase in system cost, and the like.

In addition, the image processing device 100 is configured to detect an abnormality in the second video, and to cause the display device 120 to display the first video instead of the second video when an abnormality is detected in the second video. As a result, for example, when an abnormality occurs in the second video output by the image processing unit 102 when the vehicle 10 is backing up or the like, the image processing device 100 can cause the first video to be output to the display device 120 in place of the second video.

As described above, in accordance with the vehicle surroundings monitoring system 1 according to the present embodiment, it is possible to display the video in which the surroundings of the vehicle 10 are captured, with high reliability, and to easily provide various types of image-processed content using the video.

Hardware Configuration

Hardware Configuration of Image Processing Device

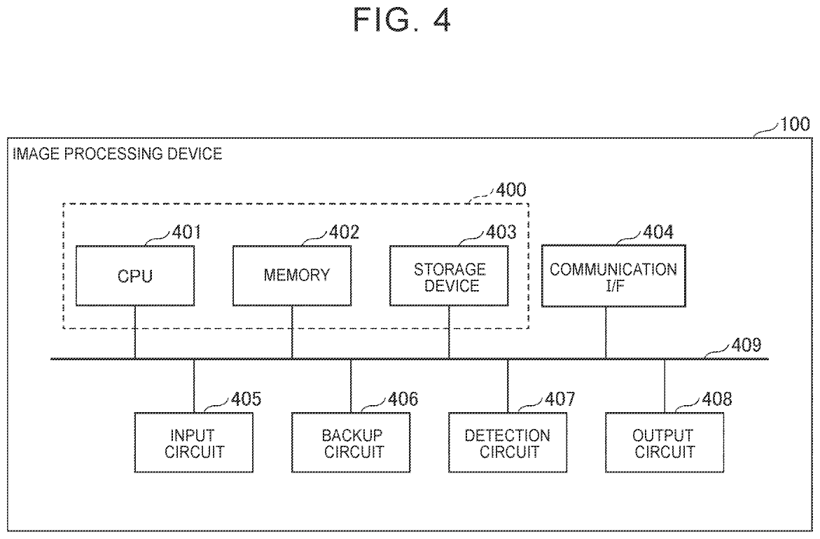

FIG. 4 is a diagram showing an example of a hardware configuration of the image processing device according to the present embodiment. The image processing device 100 has a computer configuration, and includes, for example, a central processing unit (CPU) 401, a memory 402, a storage device 403, a communication OF 404, an input circuit 405, a backup circuit 406, a detection circuit 407, an output circuit 408, a bus 409, and the like.

The CPU 401 is a processor that controls the entire image processing device 100 by executing a predetermined program stored in a storage medium such as the memory 402 or the storage device 403, for example. The memory 402 includes, for example, a random access memory (RAM) that is a volatile memory used as a working area, etc., of the CPU 401, a read-only memory (ROM) in which a program, etc., for starting the CPU 401 is stored in advance, and the like. The storage device 403 is, for example, a large-capacity non-volatile storage device such as a flash ROM. Note that the CPU 401, the memory 402, the storage device 403, and the like may be included in one device such as a microcomputer 400.

The communication OF 404 includes, for example, a network interface for connecting the image processing device 100 to an in-vehicle network of the vehicle 10 and communicating with other ECUs. Also, the communication OF 404 may include a communication interface such as wireless LAN, short-range wireless communication, or USB, for example, for communicating with an information terminal such as a smartphone.

The input circuit 405 is an interface for inputting, for example, the first video, other videos, or the like to the image processing device 100. The backup circuit 406 is, for example, a circuit corresponding to the backup unit 105 in FIG. 1. As an example, the backup circuit 406 includes a small microcomputer and a storage medium storing a program for causing the microcomputer to function as the backup unit 105.

The detection circuit 407 is, for example, a circuit corresponding to the detection unit 103 in FIG. 1, and includes a signal processing circuit that detects fixing (freezing) of an input video, presence or absence of an input video, or the like, a processor for signal processing, or the like. The output circuit 408 is an interface for the image processing device 100 to output a video, a control signal, or the like. The bus 409 is connected to each component described above, and transmits, for example, an address signal, a data signal, various control signals, and the like.

Note that the hardware configuration of the image processing device 100 shown in FIG. 4 is an example. For example, the image processing device 100 may further include hardware for image processing. Further, the detection unit 103, the backup unit 105, or the like in FIG. 1 may be implemented by a program executed by the CPU 401.

Hardware Configuration of Video Output Device

The video output device 110 may be of any hardware configuration (e.g., camera, ECU, etc.) as long as it is a device that outputs the first video including the video in which the area behind the vehicle 10 is captured to the image processing device 100. Therefore, the description thereof is omitted here.

Hardware Configuration of Display Device

The display device 120 may be, for example, a typical display device having a display such as an LCD or an OLED, a display controller, and a computer configuration. The setting unit 122 and the setting switching unit 123 in FIG. 1 are implemented by, for example, a program executed by a computer included in the display device 120.

Processing Flow

Next, the flow of processing of the vehicle surroundings monitoring method according to the present embodiment will be described.

Display Processing 1 for Rear Video

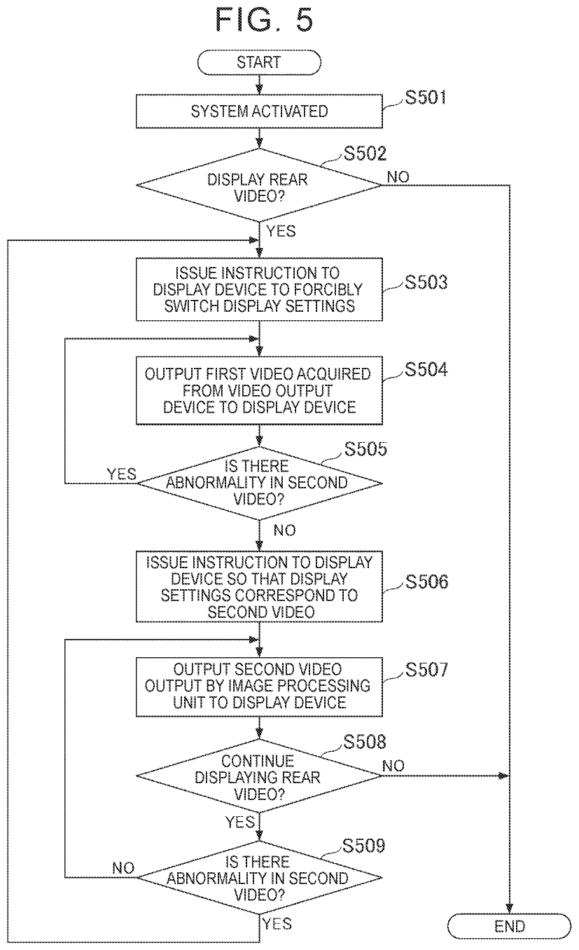

FIG. 5 is a flowchart showing an example of display processing of a rear video according to the present embodiment. The processing shows an example of the display processing of the rear video that is executed by the image processing device 100 immediately after the vehicle surroundings monitoring system 1 described with reference to FIG. 1 is activated or restarted, for example. In the image processing device 100, it takes time to activate the image processing unit 102, and the other units such as the acquisition unit 101, the detection unit 103, the video switching unit 104, and the backup unit 105 are activated first.

In step S501, when the vehicle surroundings monitoring system 1 is activated or restarted, the image processing device 100 executes the process of step S502 and onward.

In step S502, the image processing device 100 determines whether to display the rear video of the vehicle 10. For example, the image processing device 100 determines to display the rear video when the first video is output by the video output device 110. Alternatively, the image processing device 100 may determine to display the rear video when the vehicle 10 is backing up.

When displaying the rear video, the image processing device 100 proceeds the process to step S503. On the other hand, when not displaying the rear video, the image processing device 100 terminates the processing in FIG. 5.

After the process proceeds to step S503, the instruction unit 106 of the image processing device 100 issues an instruction to the display device 120 to forcibly switch the display settings. In accordance with the instruction, the setting switching unit 123 of the display device 120 forcibly switches the setting of the display unit 121 to the setting for the first video.

In step S504, the video switching unit 104 of the image processing device 100 outputs the first video acquired from the video output device 110 by the acquisition unit 101 to the display device 120. As a result, the first video is displayed on the display device 120.

In step S505, the detection unit 103 of the image processing device 100 determines (detects) whether there is an abnormality in the second video output by the image processing unit 102. For example, when the image processing unit 102 does not output the second video, or when the second video output by the image processing unit 102 is fixed (frozen), the detection unit 103 determines that there is an abnormality in the second video.

When there is no abnormality in the second video, the image processing device 100 proceeds the process to step S506. On the other hand, when there is an abnormality in the second video, the image processing device 100 repeats the processes of step S504 and step S505 until there is no abnormality in the second video.

When the process proceeds to step S506, the image processing unit 102 of the image processing device 100 issues an instruction to the display device 120 so that the display settings correspond to the second video. Accordingly, the setting unit 122 of the display device 120 sets the display settings for the second video instructed by the image processing device 100 to the display unit 121, for example.

In step S507, the video switching unit 104 of the image processing device 100 outputs the second video output by the image processing unit 102 to the display device 120.

In step S508, the image processing device 100 determines whether to continue displaying the rear video of the vehicle 10. For example, the image processing device 100 determines to continue displaying the rear video when the first video is output by the video output device 110. Alternatively, the image processing device 100 may determine to continue displaying the rear video when the vehicle 10 is backing up.

When continuing to display the rear video, the image processing device 100 proceeds the process to step S509. On the other hand, when not continuing to display the rear video, the image processing device 100 terminates the processing in FIG. 5.

After the process proceeds to step S509, the detection unit 103 of the image processing device 100 determines whether there is an abnormality in the second video output by the image processing unit 102, in the same manner as in step S505.

When there is an abnormality in the second video, the image processing device 100 proceeds the process to step S503. On the other hand, when there is no abnormality in the second video, the image processing device 100 repeats the processes of steps S507 to S509.

With the processing in FIG. 5, the image processing device 100 can cause the first video to be displayed on the display device 120 when the image processing unit 102 is being activated (or restarted) and the second video cannot be output, and when the second video output by the image processing unit 102 is fixed.

Display Processing 2 for Rear Video

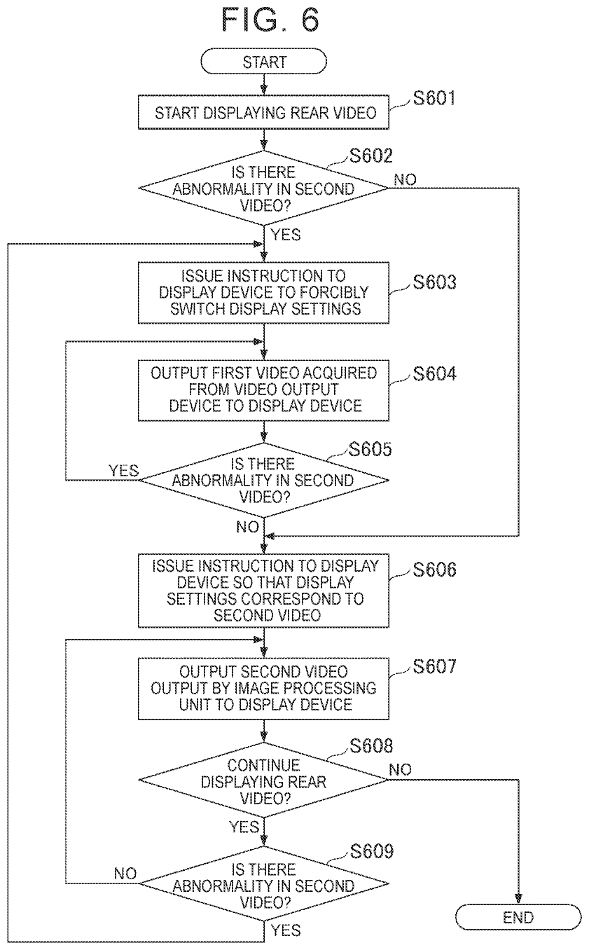

FIG. 6 is a flowchart showing another example of the display processing of the rear video according to the present embodiment. The processing shows an example of the display processing of the rear video executed when the image processing device 100 detects a display event of the rear video of the vehicle 10 in the vehicle surroundings monitoring system 1 described with reference to FIG. 1, for example.

For example, the image processing device 100 executes the processing in FIG. 6, when the video output device 110 starts outputting the first video, when the driver performs a backing up operation of the vehicle 10, or the like. Since the basic processing contents are the same as the display processing of the rear video described with reference to FIG. 5, detailed description of the same processing contents as the processing described with reference to FIG. 5 will be omitted here.

In step S601, the image processing device 100 starts displaying the rear video of the vehicle 10. For example, the image processing device 100 causes the display device 120 to display the second video that is image-processed by the image processing unit 102 using the first video acquired by the acquisition unit 101. An example of the second video will be described later.

In step S602, the detection unit 103 of the image processing device 100 determines whether there is an abnormality in the second video output by the image processing unit 102, in the same manner as in step S505 in FIG. 5. When there is an abnormality in the second video, the image processing device 100 proceeds the process to step S603. On the other hand, when there is no abnormality in the second video, the image processing device 100 proceeds the process to step S606.

After the process proceeds to step S603, the instruction unit 106 of the image processing device 100 issues an instruction to the display device 120 to forcibly switch the display settings.

In step S604, the video switching unit 104 of the image processing device 100 outputs the first video acquired from the video output device 110 by the acquisition unit 101 to the display device 120.

In step S605, the detection unit 103 of the image processing device 100 determines whether there is an abnormality in the second video output by the image processing unit 102. When there is no abnormality in the second video, the image processing device 100 proceeds the process to step S606. On the other hand, when there is an abnormality in the second video, the image processing device 100 repeats the processes of step S604 and step S605 until there is no abnormality in the second video.

When the process proceeds to step S606, the image processing unit 102 of the image processing device 100 issues an instruction to the display device 120 so that the display settings correspond to the second video.

In step S607, the video switching unit 104 of the image processing device 100 outputs the second video output by the image processing unit 102 to the display device 120.

In step S608, the image processing device 100 determines whether to continue displaying the rear video of the vehicle 10.

When continuing to display the rear video, the image processing device 100 proceeds the process to step S609. On the other hand, when not continuing to display the rear video, the image processing device 100 terminates the processing in FIG. 6.

After the process proceeds to step S609, the detection unit 103 of the image processing device 100 determines whether there is an abnormality in the second video output by the image processing unit 102. When there is an abnormality in the second video, the image processing device 100 proceeds the process to step S603. On the other hand, when there is no abnormality in the second video, the image processing device 100 repeats the processes of steps S607 to S609.

With the processing in FIG. 6, the image processing device 100 causes the display device 120 to display the image-processed second video using the first video output by the video output device 110, when displaying the rear video of the vehicle 10. Further, when there is an abnormality in the second video output by the image processing unit 102, the image processing device 100 causes the display device 120 to display the first video acquired from the video output device 110 in place of the second video.

### Example of Second Video

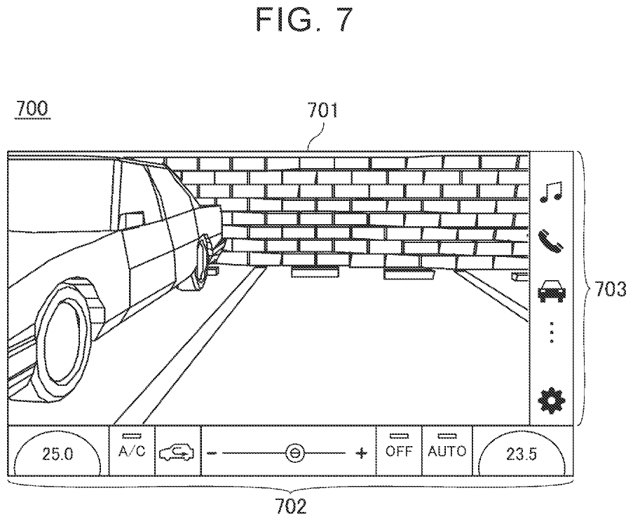

FIG. 7 is a diagram showing an example of the second video according to the present embodiment. FIG. 7 shows an image of an example of a second video 700 that is caused to be displayed on the display device 120 by the image processing device 100 in step S507 in FIG. 5, step S607 in FIG. 6, or the like, for example. In the example of FIG. 7, the second video 700 includes a rear video 701 of the vehicle 10, an operation image 702 of the air conditioner of the vehicle 10, an operation image 703 of the display device 120, and the like.

The rear video 701 is a video of the area behind the vehicle 10 that is generated by the image processing unit 102 based on the first video acquired by the acquisition unit 101. The operation image 702 of the air conditioner is an area that indicates the setting state of the air conditioner of the vehicle 10 and where operations for setting the air conditioner by an occupant are received. An operation image 703 of the display device 120 is an area where operations for selecting content, etc., displayed by the display device 120 are received.

When the rear video 701 is not displayed, for example, a content video, etc., such as a navigation image, a DVD image, or a television image is displayed in the area where the rear video 701 is displayed. The operation image 702 of the air conditioner and the operation image 703 of the display device 120 are examples of the information image of the vehicle 10 or the setting image of the vehicle 10. In the area where the operation image 702 of the air conditioner and the operation image 703 of the display device 120 are displayed, for example, a navigation function operation screen, a DVD player operation screen, a television operation screen, a setting image for performing various settings of the vehicle 10, or the like may be displayed.

As described above, the second video 700 can include various images other than the rear video 701 of the vehicle 10. However, there is a problem that it is difficult to ensure reliability.

Therefore, the image processing device 100 according to the present embodiment causes the display device 120 to display the first video acquired from the video output device 110 in place of the second video 700, for example, when the second video 700 is fixed, or when the image processing unit 102 is restarted or the like.

As described above, in accordance with the present embodiment, it is possible that the vehicle surroundings monitoring system 1 displays the video in which the surroundings of the vehicle 10 are captured, with high reliability, and easily provides various types of image-processed content using the video.

The embodiments of the present disclosure have been described above. However, the present disclosure is not limited to the embodiments, and within the scope of the gist of the disclosure described in the claim, various modifications, changes, or applications can be carried out.

What is claimed is:

1. A vehicle surroundings monitoring system comprising:
an acquisition unit configured to acquire a first video including a video in which an area behind a vehicle is captured;
an image processing unit configured to generate a second video to be displayed on a display unit of the vehicle, based on the first video;
a video switching unit that is configured such that the first video and the second video are input, and that is configured to output the first video or the second video to the display unit in accordance with a state of the second video; and
a setting switching unit configured to forcibly switch a setting of the display unit to a setting for the first video when the video switching unit outputs the first video.

2. The vehicle surroundings monitoring system according to claim 1, comprising:
a video output device that outputs the first video;
an image processing device that includes the acquisition unit, the image processing unit, and the video switching unit; and
a display device that includes the display unit and the setting switching unit.

3. The vehicle surroundings monitoring system according to claim 1, wherein the image processing unit uses the first video to further generate content to be provided to an outside.

4. The vehicle surroundings monitoring system according to claim 1, comprising a detection unit configured to detect an abnormality in the second video, wherein the video switching unit
outputs the first video to the display unit when the abnormality is detected in the second video, and
outputs the second video to the display unit when the abnormality is not detected in the second video.

5. The vehicle surroundings monitoring system according to claim 4, wherein when the image processing unit does not output the second video, or when the second video output by the image processing unit is fixed, the detection unit determines that the abnormality is present in the second video.

6. The vehicle surroundings monitoring system according to claim 1, wherein the second video includes a navigation image, a content video, a display image of vehicle information, a setting image of the vehicle, or an image of an operation button.

7. The vehicle surroundings monitoring system according to claim 1, wherein the setting for the first video includes a setting value of luminance, contrast, or brightness that is needed to display the first video.

8. A vehicle equipped with the vehicle surroundings monitoring system according to claim 1.

9. An image processing device comprising:
an acquisition unit configured to acquire a first video including a video in which an area behind a vehicle is captured;
an image processing unit configured to generate a second video to be displayed on a display unit of the vehicle, based on the first video; and
a video switching unit that is configured such that the first video and the second video are input, and that is configured to output the first video or the second video to the display unit in accordance with a state of the second video, wherein the image processing device forcibly switches a setting of the display unit to a setting for the first video when the video switching unit outputs the first video.

10. A vehicle surroundings monitoring method, wherein a vehicle surroundings monitoring system executes:
a process of acquiring a first video including a video in which an area behind a vehicle is captured;
a process of generating a second video to be displayed on a display unit of the vehicle, based on the first video;
a process of acquiring the first video and the second video, and outputting the first video or the second video to the display unit in accordance with a state of the second video; and
a process of forcibly switching a setting of the display unit to a setting for the first video when the first video is output.
